(19) United States
(12) Patent Application Publication
(10) Pub. No.: US 2014/0301174 A1
(43) Pub. Date: Oct. 9, 2014

(54) OPTICAL DISK DEVICE AND METHOD OF DRIVING THE SAME

(71) Applicant: FUNAI ELECTRIC CO., LTD., Osaka (JP)

(72) Inventor: Tsuyoshi EIZA, Osaka (JP)

(73) Assignee: FUNAI ELECTRIC CO., LTD., Osaka (JP)

(21) Appl. No.: 14/230,245

(22) Filed: Mar. 31, 2014

(30) Foreign Application Priority Data
Apr. 4, 2013 (JP) 2013-078623

(51) Int. Cl. G11B 7/09

(52) U.S. Cl. CPC G11B 7/0925
USPC 369/47.49

(57) ABSTRACT

An optical disk device including: an optical pickup which includes a collimator and an object lens for focusing parallel light beams from the collimator at a position on an optical disc; a collimator driver unit which moves the collimator in an optical axis direction; a movement mechanism driver unit which moves the optical pickup in the radial direction; and a drive control unit which performs an adjustment process for adjusting the positions of the object lens and the collimator. In the adjustment process, the drive control unit causes the collimator driver unit to operate after stopping the movement mechanism driver unit or a spindle motor, and causes the movement mechanism driver unit or the spindle motor to re-start operating after the collimator driver unit finishes moving the collimator.

### CROSS REFERENCE TO RELATED APPLICATION

The present application is based on and claims priority of Japanese Patent Application No. 2013-078623 filed on Apr. 4, 2013. The entire disclosure of the above-identified application, including the specification, drawings and claims is incorporated herein by reference in its entirety.

### FIELD

The present invention relates to an optical disk device and a method of driving the same.

### BACKGROUND

Optical disk devices are devices which read or write data from or on one or more kinds of media such as Digital Versatile Disks (DVDs) or Blu-ray (registered trademark) Discs (BDs). An exemplary optical disk device is configured to include a spindle motor which controls rotation of an optical disc and a spindle motor driver unit which controls the spindle motor, an optical pickup which reads data stored in the optical disc, a control unit which controls each of structural units of the optical disk device, etc.

### CITATION LIST

### Patent Literature

### PTL 1

Japanese Unexamined Patent Application Publication No. 2007-234084

### SUMMARY

### Technical Problem

There are demands for further reduction in power consumption at a peak time.

The present invention was made to solve the above-described problem, with an aim to provide an optical disk device which is capable of reducing power consumption.

### Solution to Problem

In order to achieve the above object, an optical disk device according to an aspect of the present invention includes: an optical pickup which (i) includes a collimator for collimating light from a predetermined light source to parallel light beams, and an object lens for focusing the parallel light beams from the collimator at a position on an optical disc, and (ii) reads data recorded on the optical disc; a collimator driver unit configured to move the collimator in an optical axis direction; an optical pickup movement unit configured to move the optical pickup in a radial direction of the optical disc; and a drive control unit configured to perform an adjustment process for adjusting positions of the object lens and the collimator, wherein, in the adjustment process, the drive control unit is configured to cause the collimator driver unit to operate after stopping the optical pickup movement unit, and cause the optical pickup movement unit to re-start operating after the collimator driver unit finishes moving the collimator.

The optical disk device configured as described above causes the optical pickup movement unit to operate during the period other than the period in which the collimator driver unit which consumes the large amount of power is operating, and thus can suppress the peak of power to be consumed.

In order to achieve the above object, an optical disk device according to an aspect of the present invention includes: an optical pickup which (i) includes a collimator for collimating light from a predetermined light source to parallel light beams, and an object lens for focusing the parallel light beams from the collimator at a position on an optical disc, and (ii) reads data recorded on the optical disc; a collimator driver unit configured to move the collimator in an optical axis direction; an optical disc rotation unit configured to rotate the optical disc; and a drive control unit configured to perform an adjustment process for adjusting positions of the object lens and the collimator, wherein, in the adjustment process, the drive control unit is configured to cause the collimator driver unit to operate after stopping the optical disc rotation unit, and cause the optical disc rotation unit to re-start operating after the collimator driver unit finishes moving the collimator.

The optical disk device configured as described above causes the optical disc rotation unit to operate during the period other than the period in which the collimator driver unit which consumes the large amount of power is operating, and thus can suppress the peak of power to be consumed.

In addition, the optical disk device may further include an optical pickup movement unit configured to move the optical pickup in the radial direction of the optical disc, wherein, in the adjustment process, the drive control unit is configured to stop the optical pickup movement unit before causing the collimator driver unit to operate, and cause the optical pickup movement unit to re-start operating after the collimator driver unit finishes moving the collimator.

The optical disk device configured as described above causes the optical disc rotation unit and the optical pickup movement unit to operate during the period other than the period in which the collimator driver unit which consumes the large amount of power is operating, and thus can further suppress the peak of power to be consumed.

In addition, in the adjustment process, the drive control unit may be configured to cause the collimator driver unit to operate after a transition to a still mode in which (i) the parallel light beams are focused on the optical disc and (ii) a signal read from the optical pickup is not decoded, and terminate the still mode after the collimator driver unit finishes moving the collimator.

In addition, in the adjustment process, the drive control unit may be configured to focus the parallel light beams on one or more tracks on the optical disc.

In addition, in the adjustment process, the drive control unit may be configured to move the object lens in a center direction of the optical disc before causing the collimator driver unit to operate, so as to move the object lens sequentially in a peripheral direction of the optical disc for a time duration longer than time required for the collimator driver unit to move the collimator.

In addition, the control unit may be configured to perform the adjustment process when the optical disk device is turned on, or the optical disc is mounted.

In addition, the optical disk device may include a temperature sensor which detects a temperature, and outputs temperature information indicating the temperature, wherein the drive control unit may be configured to perform the adjustment process when a difference between the temperature indicated by the temperature information and a temperature at a time of a previous driving process is larger than or equal to a predetermined threshold value.

In order to achieve the above object, a driving method according to an aspect of the present invention is for use in an optical disk device which (i) includes a collimator for collimating light from a predetermined light source to parallel light beams, and an object lens for focusing the parallel light beams from the collimator at a position on an optical disc, and (ii) reads data recorded on the optical disc; a collimator driver unit which moves the collimator in an optical axis direction; an optical pickup movement unit which moves the optical pickup in a radial direction of the optical disc; and an optical disc rotation unit which rotates the optical disc. The driving method includes: stopping the optical pickup movement unit; driving the collimator driver unit to operate after stopping the optical pickup movement unit; and causing the optical pickup movement unit to re-start operating, after finishing moving the collimator by the collimator driver unit.

In order to achieve the above object, a driving method according to an aspect of the present invention is for use in an optical disk device which (i) includes a collimator for collimating light from a predetermined light source to parallel light beams, and an object lens for focusing the parallel light beams from the collimator at a position on an optical disc, and (ii) reads data recorded on the optical disc; a collimator driver unit which moves the collimator in an optical axis direction; an optical pickup movement unit which moves the optical pickup in a radial direction of the optical disc; and an optical disc rotation unit which rotates the optical disc. The driving method includes: stopping the optical disc rotation unit; driving the collimator driver unit to operate after stopping the optical disc rotation unit; and causing the optical disc rotation unit to re-start operating, after finishing moving the collimator by the collimator driver unit.

The present invention can be realized as a program for causing a computer to execute the unique steps corresponding to the method for driving the optical disk device. Furthermore, the program can naturally be distributed using computer-readable non-transitory recording media such as Compact Disc Read Only Memories (CD-ROMs), or through communication networks such as the Internet.

### Advantageous Effects

The present invention provides an optical disk device capable of reducing power consumption at a peak time and a method of driving the optical device.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a block diagram showing an example of a structure of an optical disk device according to Embodiment 1.

FIG. 2 is a flowchart showing an example of a mounting procedure in the optical disk device according to Embodiment 1.

FIG. 3 is a graph showing transitional relationships between the position of an object lens, the position of an optical pickup, and consumed power according to Embodiment 1.

FIG. 4 is a flowchart showing an example of a temperature adjustment procedure in the optical disk device according to Embodiment 1.

FIG. 5 is a graph showing transitional relationships between the position of an object lens, the position of an optical pickup, and consumed power in a conventional optical disk device.

FIG. 6 is a graph showing an optical pickup movement mechanism and a waveform of a driving current in the mounting performed by the optical disk device according to Embodiment 1.

FIG. 7 is a graph showing an optical pickup movement mechanism and a waveform of a driving current of the collimator driver unit in the temperature adjustment process in the optical disk device according to Embodiment 1.

FIG. 8 is a flowchart showing an example of a mounting procedure in an optical disk device according to Embodiment 2.

FIG. 9 is a graph showing transitional relationships between the position of an object lens, the position of an optical pickup, and consumed power according to Embodiment 2.

FIG. 10 is a flowchart showing an example of a temperature adjustment procedure in the optical disk device according to Embodiment 2.

FIG. 11 is a flowchart showing an example of a mounting process in an optical disk device according to Embodiment 3.

FIG. 12 is a graph showing transitional relationships between the position of an object lens, the position of an optical pickup, and consumed power according to Embodiment 4.

FIG. 13 is a flowchart showing an example of a temperature adjustment procedure in an optical disk device according to Embodiment 4.

### DESCRIPTION OF EMBODIMENTS

Hereinafter, embodiments according to the present invention are described in detail with reference to the drawings. It is to be noted that each of the drawings does not always show the exact dimensions, ratios, or the like.

The embodiments below explain preferred specific examples of the present invention. In the embodiments below, the numerical values, shapes, materials, structural elements, the arrangement and connection of the structural elements, steps, the processing order of the steps etc. are mere examples, and therefore do not limit the scope of the present invention. The present invention is determined based on the Claims. Therefore, among the structural elements in the following exemplary embodiments, structural elements not recited in any one of the independent claims are not necessarily required to achieve the object of the present invention, but explained as the ones which constitute the preferred embodiments.

### Embodiment 1

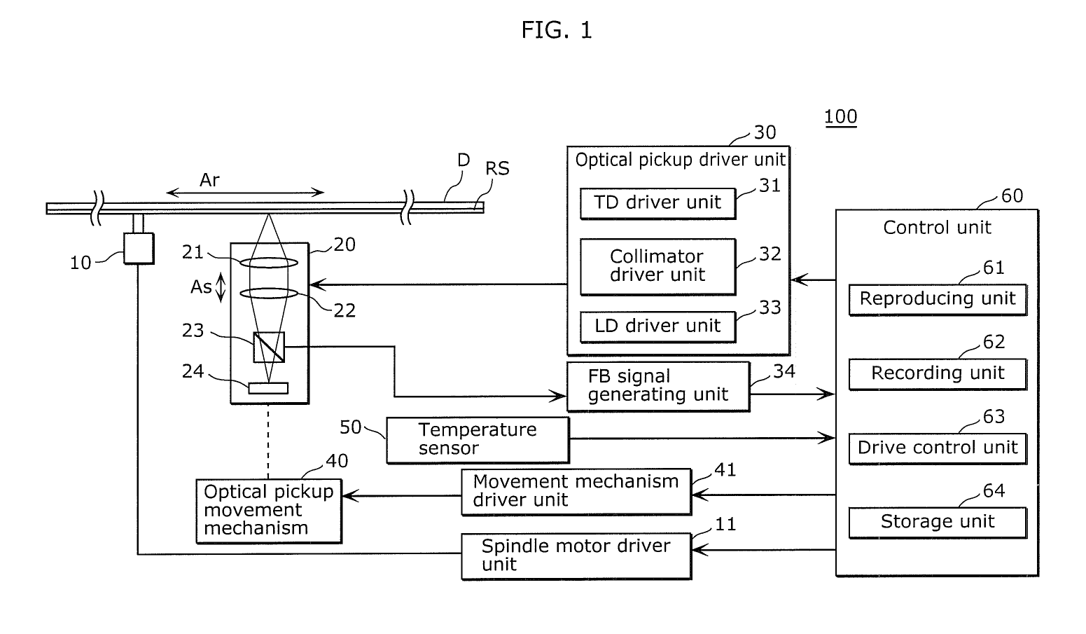

An optical disk device according to Embodiment 1 is explained based on FIGS. 1 to 4.

The optical disk device according to this embodiment performs control for driving an optical pickup movement mechanism during a period other than a period in which a collimator that consumes a large amount of power is driven, for the purpose of reducing a peak of power to be consumed to drive the optical pickup.

### [1-1. The Structure of an Optical Disk Device]

An optical disk device 100 is explained based on FIG. 1. FIG. 1 is a block diagram showing a structure of the optical disk device 100.

As shown in FIG. 1, the optical disk device 100 includes the following structural units:

(1) a spindle motor 10 which rotates an optical disc and a spindle motor driver unit 11 which controls the spindle motor 10;

(2) an optical pickup 20 which reads data recorded in the optical disc;

(3) an optical pickup driver unit 30 and an FD signal generating unit 34 which control driving of optical members which constitute the optical pickup 20;

(4) an optical pickup movement mechanism 40 and a movement mechanism driver unit 41 (an optical pickup movement unit) which control movement in a radial direction Ar of the optical pickup 20;

(5) a temperature sensor 50; and

(6) a control unit 60 which controls structural units of the optical disk device 100.

(1) The spindle motor 10 is an example of the optical disc rotation unit, and is a mechanism for rotating an optical disc D. The spindle motor 10 is connected to a turn table. The turn table is a member which mounts the optical disc D, and rotates according to driving of the spindle motor 10 at the time of reproducing or recording data in or onto the optical disc D. At the time of reproducing or recording data in or onto the optical disc D, the optical disc D can be rotated by rotating a turn table with the optical disc D mounted.

The spindle motor driver unit 11 drives the spindle motor 10 by supplying a driving current to the spindle motor 10 according to control by the control unit 60.

(2) The optical pickup 20 is configured with an optical member which focuses light onto an information recording surface RS of the optical disc D, receives a reflected light, and reads data stored on the information recording surface RS. It is to be noted that the optical pickup 20 may include a function for writing data onto the optical disc D.

Although not shown, the optical pickup 20 is supported by two guide shafts provided in the optical disk device 100, and is movable along the guide shafts. The guide shafts are arranged toward a radial direction Ar, which allows the optical pickup 20 to move in the radial direction Ar.

As shown in FIG. 1, the optical pickup 20 includes, as optical members, an object lens 21, a collimator 22, a beam splitter 23, an LD (semiconductor laser) 24, and an optical detector unit (not shown).

The object lens 21 is a member which is configured to focus light from the LD 24 via the collimator 22 on an arbitrary position on the information recording surface RS, and to be movable in the radial direction Ar and the optical axis direction As. For focus adjustment, the position of the object lens 21 in the optical axis direction As is adjusted. In order to collect light to a track (groove) of the optical disc D, the position of the object lens 21 in the radial direction Ar is adjusted. This embodiment explains an example where the object lens 21 is movable by four tracks in the radial direction Ar, specifically, from a predetermined position at a center side (hereinafter referred to as a “center position”) to a predetermined position at a trace side (hereinafter referred to as a “trace position”).

The collimator 22 is a member which is configured to correct a spherical aberration in the object lens 21, and to be movable in the optical axis direction As. The collimator 22 collimates light from the LD 24 (to parallel light beams) and to be focused on via the beam splitter 23. By moving the collimator 22 in the optical axis direction As and adjusting the distance between the collimator 22 and the object lens 21, it is possible to adjust convergence and divergence (parallelism) of the parallel light beams to be incident to the object lens 21. In this way, it is possible to control influence of the spherical aberration

The beam splitter 23 passes through light from the LD 24 so that the light enters the collimator 22. In addition, the beam splitter 23 guides the light which is reflected from the optical disc D and which enters through the object lens 21 and the collimator 22 to the FB signal generating unit 34.

The LD 24 is an example of a light source, and a member for emitting light.

The optical detector unit (not shown) receives light reflected on the information recording surface RS, performs photoelectric conversion on the light, and outputs the parallel light to the control unit 60.

(3) The optical pickup driver unit 30 is configured to make adjustments for the optical members, and includes a TD driver unit 31, a collimator driver unit 32, and an LD driver unit 33.

The TD driver unit 31 controls a movement of the object lens 21 in the radial direction Ar and the optical axis direction As, using a focus error (FE) signal and a tracking error (TE) signal to be output from a later-described FD signal generating unit 34. The TD driver unit 31 generates a drive current for driving the object lens 21 in the radial direction Ar, and a drive current for driving the object lens 21 in the optical axis direction As.

The collimator driver unit 32 generates a driving current for driving the collimator 22 and outputs the driving current to the collimator 22, and thereby controls the movement of the collimator 22 in the optical axis direction As.

The LD driver unit 33 generates a driving current for driving the LD 24, and supplies the driving current to the LD 24.

The FD signal generating unit 34 generates an RF signal, an FE signal, a TE signal etc., using electric signals which are output from the optical detector unit (not shown), and outputs the generated signals to the control unit 60.

(4) The optical pickup movement mechanism 40 is an example of an optical pickup driver unit, and is, for example, configured with a teeth member having teeth which interfit recess and protrusion portions of a lead screw (a feed screw, not shown) provided parallel to the guide shaft. The teeth member is provided in the optical pickup 20. A movement of the teeth member moves the optical pickup 20 along the guide shaft.

The movement mechanism driver unit 41 controls rotation of the lead screw constituting the optical pickup movement mechanism 40, according to a signal from the control unit 60.

(5) The temperature sensor 50 is a thermistor in this embodiment. The temperature sensor 50 keeps measuring temperature, and outputs temperature information to the control unit 60.

(6) The control unit 60 is configured with a Central Processing Unit (CPU), executes a control program stored in a later-described storage unit 64, and thereby controls the structural units of the optical disk device 100.

As shown in FIG. 1, the control unit 60 includes a reproducing unit 61, a recording unit 62, a drive control unit 63, and a storage unit 64.

The reproducing unit 61 decodes an RF signal output from the FD signal generating unit 34, and outputs it to outside. Examples of output destination devices include liquid crystal displays, devices each having a function for reproducing video such as TV, devices such as speakers each having a function for outputting voice, and Personal Computers (PCs).

The recording unit 62 encodes data input from outside, outputs the data to the optical pickup 20, and writes the data onto the optical disc D.

The drive control unit 63 controls the spindle motor driver unit 11, the optical pickup driver unit 30, the movement mechanism driver unit 41, etc., based on the RF signal, FE signal, and TR signal output from the FD signal generating unit 34, and the temperature information output from the temperature sensor 50. The drive control unit 63 is described in detail later.

The storage unit 64 includes a Random Access Memory (RAM) and a Read Only Memory (ROM). The RAM temporarily stores parameters etc. necessary for various kinds of control by the control unit 60. The ROM stores the above-described control program.

### [1-2. Operations Performed by the Optical Disk Device]

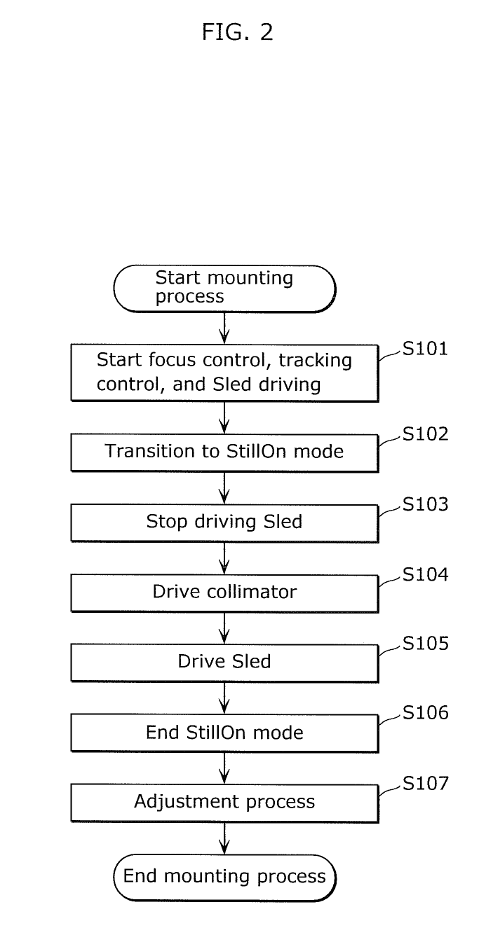

Operations by the optical disk device 100 are explained based on FIGS. 2 to 4.

Here is given a description of an adjusting process including adjustment of the positions of the object lens 21 and the collimator 22 in the optical disk device 100. This embodiment describes, as adjustment processes, a process (mounting process) which is performed according the optical disc D when the disc D is mounted or a temperature adjustment process which is performed in response to a temperature change which is detected when the optical disk device 100 is turned on.

### [1-2-1. Mounting]

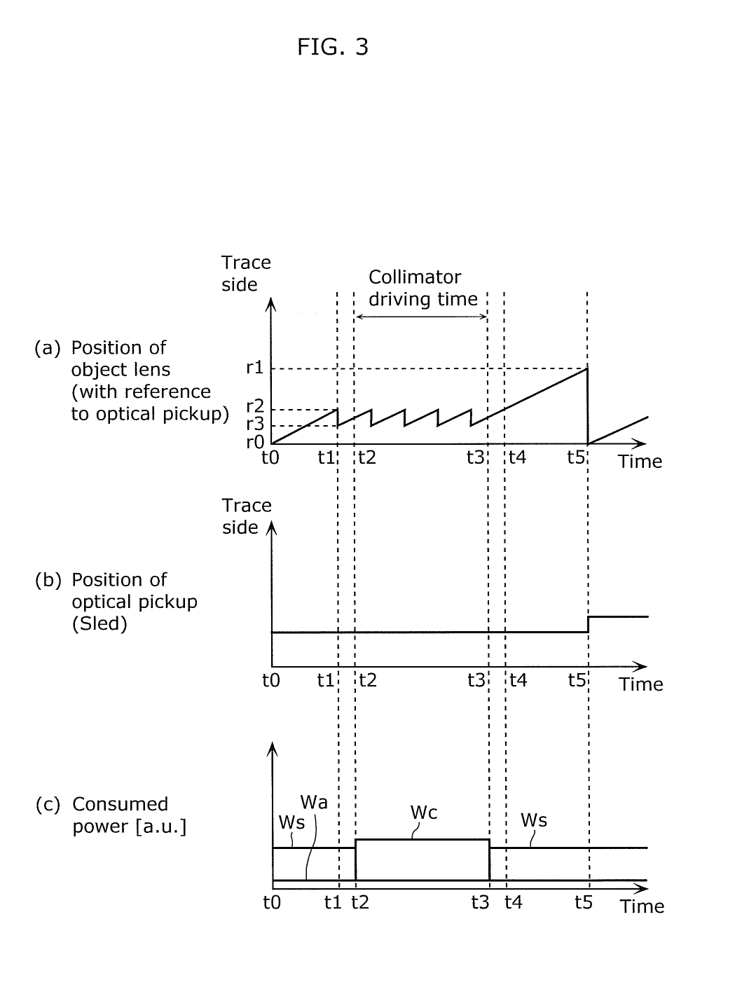

Mounting by the optical disk device 100 is explained based on FIGS. 2 and 3.

FIG. 2 is a flowchart of a mounting procedure.

FIG. 3 is a graph showing transitional relationships between the position of the object lens 21, the position of the optical pickup 20, and consumed power. In FIG. 3, (a) shows a transition in the position of the object lens 21 in the optical pickup 20. In FIG. 3, (b) shows a transition in the position of the optical pickup 20 in the optical disk device 100. In FIG. 3, (c) shows a transition in the consumed power. In (c), Wc denotes power consumed to drive the collimator 22, Ws denotes power consumed to drive the optical pickup movement mechanism 40 (to move the optical pickup 20), and Wa denotes power consumed for the structural units other than the collimator 22 and the optical pickup 20.

When mounting is started at a time t0 in FIG. 3, the drive control unit 63 starts focus adjustment and tracking control for the object lens 21 and a movement of the optical pickup 20 (hereinafter referred to as “Sled driving” as necessary) (S101 in FIG. 2). The drive control unit 63 performs the focus adjustment and tracking control for the object lens 21, according to a current temperature and the thickness of a disc.

At this time, as shown in (a) of FIG. 3, the drive control unit 63 causes the object lens 21 to move toward the trace side (the outer periphery side of the optical disc D), tracking the position of a track of the optical disc D. In (b) of FIG. 3, for explanation, the position of the optical pickup 20 is unchanged from a time 0 to a time t1. However, actually, the position of the optical pickup 20 changes, according to positioning or the like of the optical pickup 20 in the trace direction. The power consumption of the optical disk device 100 at this time is calculated according to the power consumption Ws required to move the optical pickup 20+the other power consumption Wa.

At a time t1 in FIG. 3, the drive control unit 63 transitions to a StillOn mode (S102 in FIG. 2). Here, the StillOn mode is a mode for focusing light from the LD 24 on the optical disc D without reading (decoding) an RF signal by the reproducing unit 61. In the StillOn mode, the drive control unit 63 causes the optical pickup movement mechanism 40 and the TD driver unit 31 to focus light from the LD 24 on the same one or more tracks on the optical disc D.

In the StillOn mode (the time t1 to t4 in FIG. 3), the drive control unit 63 causes the object lens 21 to repeat a movement to a position r2 at a trace side and a movement to a position r3 at a center side so that light is collected on the same one or more tracks on the optical disc D, as shown in (a) of FIG. 3. Here is shown a non-limiting case where a movement by a track is performed. As shown in (a) of FIG. 3, a position r2 is located between a center position r0 and a trace position r1, and a position r3 is located between the position r2 and the center position r0. In other words, the drive control unit 63 causes the object lens 21 to return to the position r3 at the center side at a certain cycle. In addition, the drive control unit 63 does not move the optical pickup 20 in the StillOn mode. The power consumption of the optical disk device 100 at this time is calculated according to the power consumption Ws required to move the optical pickup 20+the power consumption Wa.

At time t2 in FIG. 3, the drive control unit 63 causes the movement mechanism driver unit 41 to stop driving the optical pickup movement mechanism 40 (S103 in FIG. 2, a step of stopping the optical pickup movement unit), and adjusting the position of the collimator 22 (S104, a step of causing the collimator driver unit to operate). Here, the position of the collimator 22 is adjusted, for example, such that the condensation of light beams on the optical disc D falls within a certain range. The drive control unit 63 is capable of determining whether or not the condensation falls within the certain range, based on signals (a TE signal, an FE signal, etc.) from the FD signal generating unit 34 which receives light reflected from the optical disc D.

A power consumed in a period (the time t2 to t3 in FIG. 3) in which the collimator 22 is driven is calculated according to power consumption Wc required to drive the collimator 22+the other power consumption Wa.

When the adjustment for the collimator 22 is finished, and the driving of the collimator 22 is stopped (at the time t3 in FIG. 3), the drive control unit 63 re-starts driving of the optical pickup movement mechanism 40 and causes the optical pickup 20 to re-start moving (S105 in FIG. 2, a step of causing the optical pickup movement unit to re-start operating). Furthermore, at the time t4 in FIG. 3, the StillOn mode is terminated (S106 in FIG. 2).

After the StillOn mode is terminated at the time t4, the drive control unit 63 performs an adjustment for another mechanism (S107). At this time, the drive control unit 63 causes the object lens 21 to repeat a movement to the trace position r1 and a movement to the center position r0. Furthermore, when the object lens 21 moves to the trace position as shown at a time t5 for example, the drive control unit 63 causes the optical pickup 20 in the trace direction.

The power consumption of the optical disk device 100 at this time is calculated according to the power consumption Ws required to move the optical pickup 20+the other power consumption Wa.

As described above, as shown in (c) of FIG. 3, a value indicating a peak of the power consumed by the optical disk device 100 in mounting is calculated according to the power consumption Ws required to move the optical pickup 20+the other power consumption Wa.

### [1-2-2. A Temperature Adjustment Process]

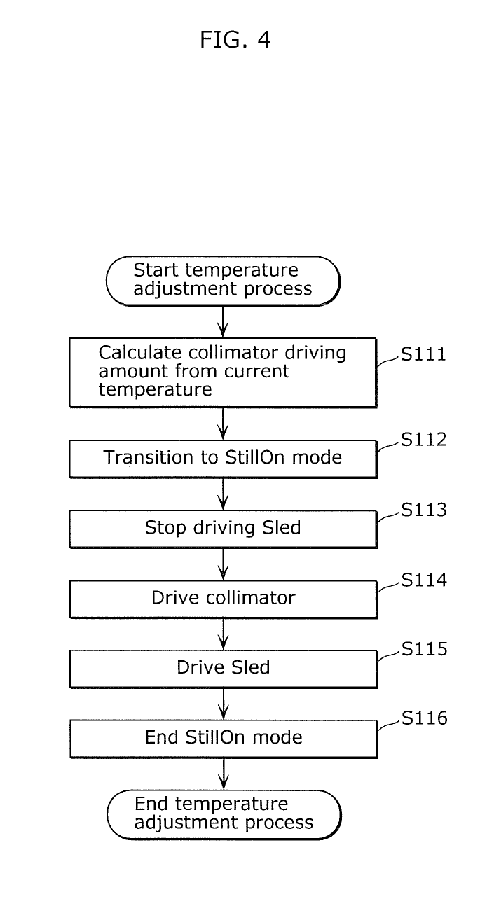

A temperature adjustment process performed by an optical disk device 100 is explained based on FIG. 4.

FIG. 4 is a flowchart of a procedure of the temperature adjustment process.

Here, in an exemplary case of the object lens 21 formed using an optical resin, a change in the temperature at the peripheral part of the object lens 21 results in a change in the refractive index thereof with a spherical aberration. For this reason, when the temperature change reaches or exceeds a certain level, the position of the collimator 22 is adjusted, and a temperature adjustment process is performed to suppress such spherical aberration due to a change in refractive index.

Here, in this embodiment, the temperature adjustment process is performed each time a previously adjusted temperature of the optical pickup 20 changes by 10 degrees Celsius, based on temperature information from the temperature sensor 50. It is to be noted that the timing at which the temperature adjustment process is performed is not limited to the timing at which the temperature changes by 10 degrees Celsius. In the temperature adjustment process, a tilt amount of the object lens 21 is re-adjusted, and the position of the collimator 22 is re-adjusted.

When the temperature adjustment process is started, the drive control unit 63 of the control 60 calculates a driving amount (a movement amount) of the collimator 22, using the previously adjusted temperature and a current temperature of the optical pickup 20 (S111). The movement amount for the collimator 22 is calculated, for example, such that the condensation of light beams on the optical disc D falls within a certain range.

The drive control unit 63 causes the reproducing unit 61 to stop reading (decoding) an RF signal, and makes a transition to a StillOn mode (S112).

The drive control unit 63 causes the optical pickup movement mechanism 40 to stop a movement of the optical pickup 20 (S113, a step of stopping the optical pickup movement unit).

The power consumed by the optical disk device 100 in S111 to S113 is calculated according to the power consumption Ws required to move the optical pickup 20+the power consumption Wa.

After stopping the movement of the optical pickup 20, the drive control unit 63 drives the collimator 22 (S114, a step of causing the collimator driver unit to operate).

The power consumption of the optical disk device 100 at this time is calculated according to the power consumption Wc required to move the collimator+the other power consumption Wa.

The drive control unit 63 causes the optical pickup movement mechanism 40 to re-start a movement of the optical pickup 20 (S115, a step of causing the optical pickup movement unit to re-start operating), and terminates the StillOn mode (S116).

Here, the collimator 22 and the optical pickup 20 (Sled) are not driven at the same time also in the temperature adjustment process, and thus a peak value in power consumed by the optical disk device 100 is calculated according to the power consumption Wc required to move the collimator 22+the other power consumption Wa, as shown in (c) in FIG. 3.

### [1-3. A Conclusion Etc.]

The optical disk device 100 in this embodiment causes the optical pickup movement mechanism 40 to operate during a period other than the driving period of the collimator 22 which consumes a large power. For this reason, as shown in (c) of FIG. 3, the peak value in the power consumed by the optical disk device 100 is calculated according to the power consumption Wc required to move the collimator 22+the other power consumption Wa.

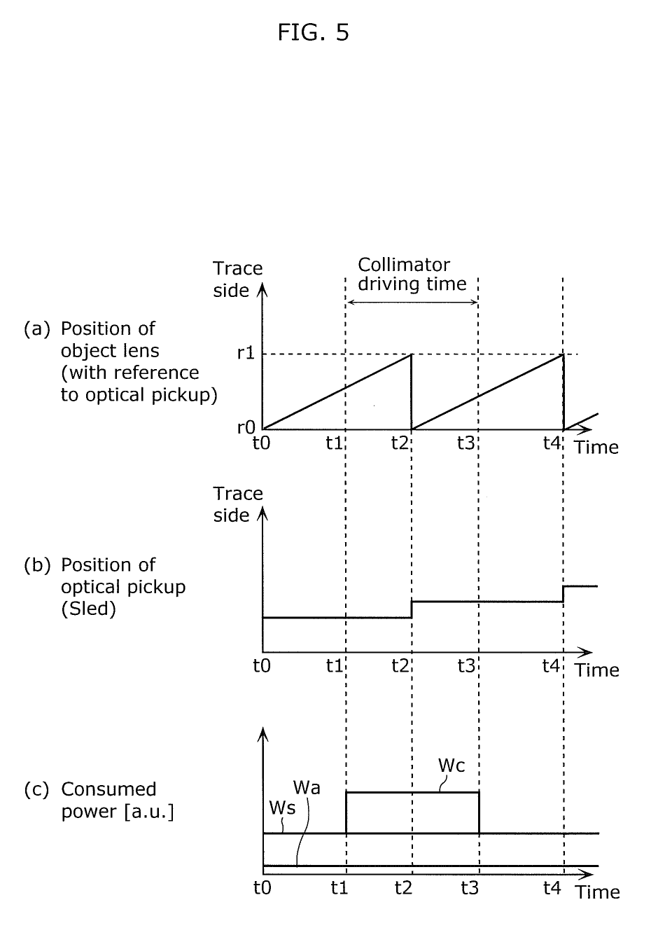

Here, FIG. 5 shows a transition in the position of the object lens of the optical pickup in a conventional optical disk device, a transition in the position of the optical pickup, and a transition in power consumed by the conventional optical disk device. As shown in (a) of FIG. 5, the object lens repeats a movement to the trace position r1 and a movement to the center position r0, following one or more tracks of the optical disc. As shown in (b) of FIG. 5, the optical pickup moves in the trace direction (the time t2 and the time t4) when the object lens moves to the trace position r1.

As shown in (c) of FIG. 5, the peak value in the power consumed by the conventional optical disk device is calculated according to a power consumption Ws required to drive the Sled+a power consumption Wc required to move the collimator 22+the other power consumption Wa.

In other words, the optical disk device 100 in this embodiment is capable of reducing a power peak value by the power consumption Ws required to drive the Sled.

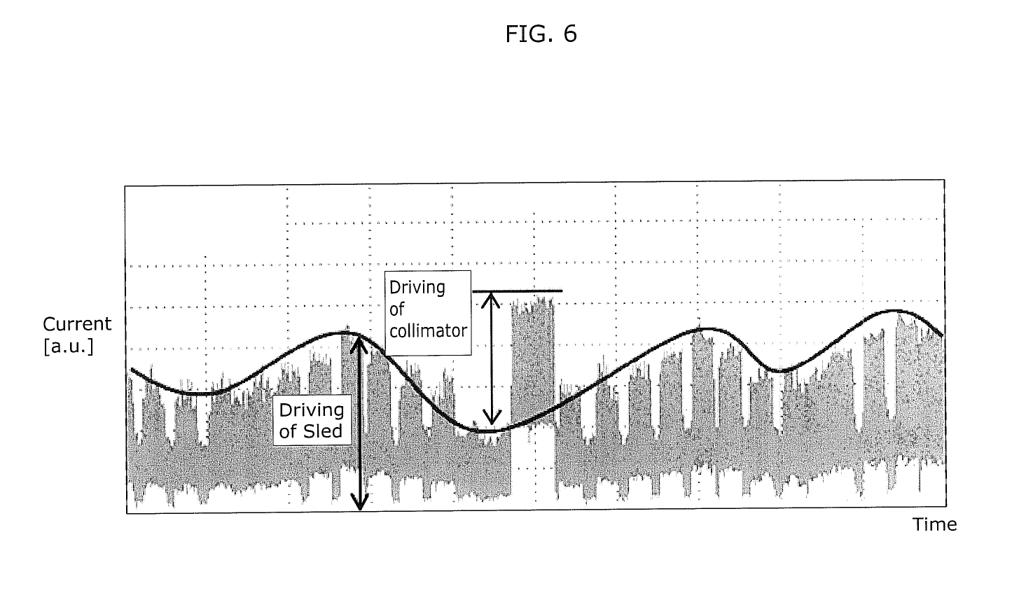

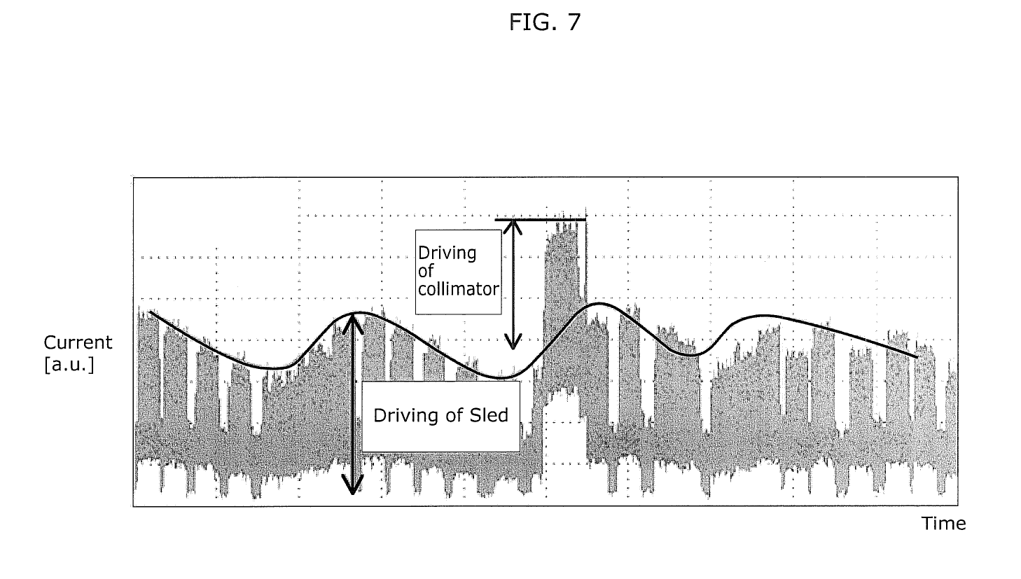

In addition, FIG. 6 shows a result of actually measuring a transition in power consumed when mounting is executed in the optical disk device 100 in this embodiment. FIG. 7 shows a result of actually measuring a transition in power consumed when a temperature adjustment process is executed in the optical disk device 100 in this embodiment.

In each of FIG. 6 and FIG. 7, a solid line shows a current waveform of a drive current (which is simply denoted as “current” in FIGS. 6 and 7) used to drive the Sled (to drive the optical pickup movement mechanism 40). In each of FIG. 6 and FIG. 7, a solid-line portion around the peak shows a period in which the Sled is driven, and a solid-line portion around a bottom part corresponds to a period in which the Sled is stopped. As shown from each of FIG. 6 and FIG. 7, the collimator 22 drives during the period in which the Sled is stopped, and the peak of the drive current in the driving of the Sled is suppressed.

Here, a power consumption Wc required to drive the collimator 22 is, for example, 8.5 W. The power consumption Ws required to move the optical pickup 20 is, for example, 7.5 W. The power consumption Wa required for elements other than the collimator 22 and the optical pickup 20 is, for example, 2 W.

In this case, the peak value in the power consumed by the optical disk device 100 in this embodiment is 10.5 W while the peak value in the power consumed by the conventional optical disk device is 18 W. This shows that the peak value in the consumed power is suppressed.

### Embodiment 2

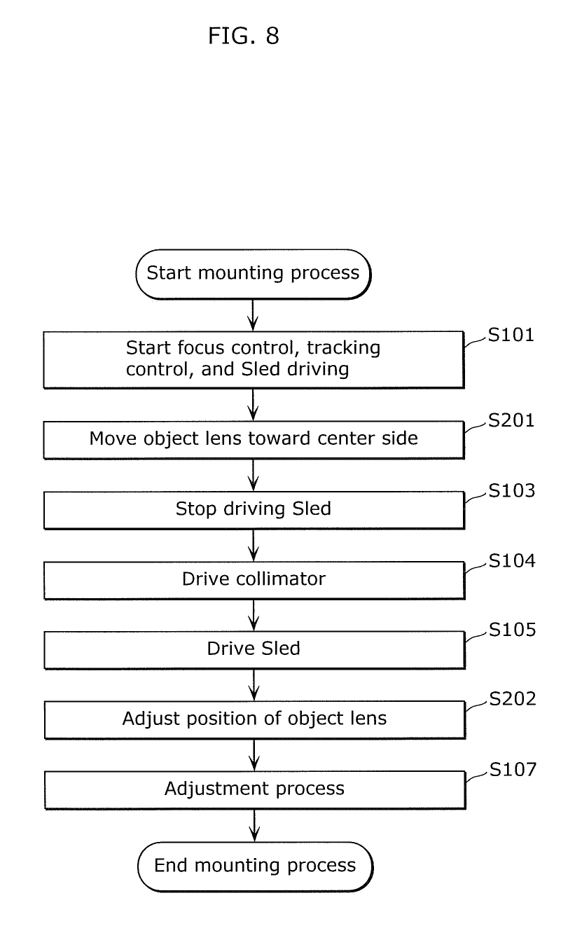

An optical disk device according to Embodiment 2 is explained based on FIGS. 8 to 10.

This embodiment explains a case where an object lens 21 and an optical pickup movement mechanism 40 (optical pickup 20) are driven by a drive control unit 63 using driving methods different in those in Embodiment 1.

It is to be noted that the optical disk device in this embodiment is the same as the optical disk device 100 shown in FIG. 1 except for the driving methods by the drive control unit 63.

### [2-1. Operations Performed by Optical Disk Device]

Operations by the optical disk device 100 are explained based on FIGS. 8 to 10.

In this embodiment, as in Embodiment 1, a mounting process and a temperature adjustment process are explained as adjustment processes by the optical disk device 100.

### [2-1-1. Mounting]

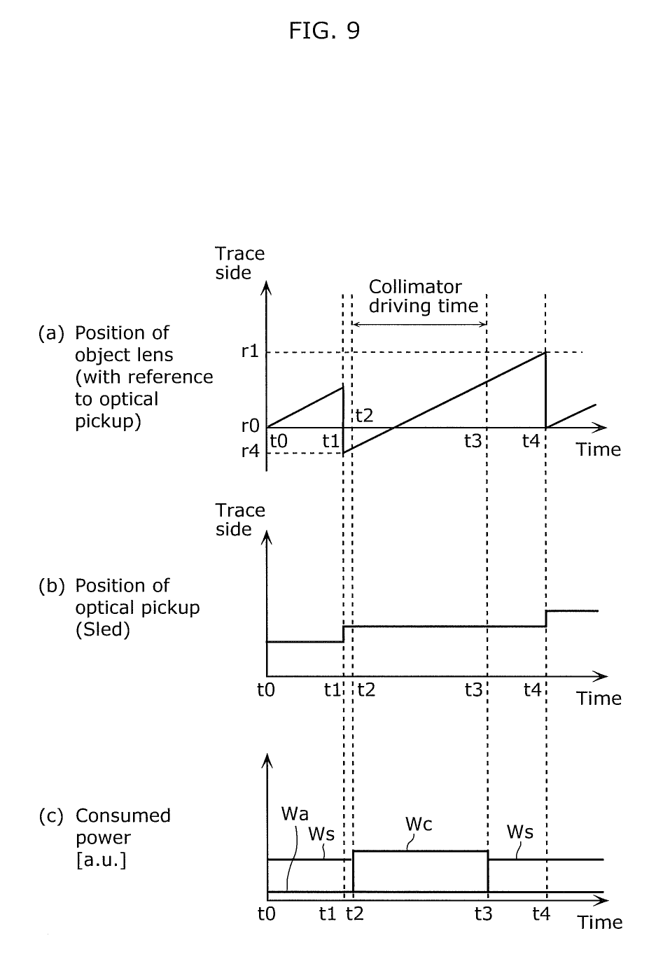

Mounting by the optical disk device 100 in this embodiment is explained based on FIGS. 8 and 9.

FIG. 8 is a flowchart of a mounting procedure. Here, the same steps as in Embodiment 1 shown in FIG. 2 are assigned with the same reference numerals.

FIG. 9 is a graph showing transitional relationships between the position of the object lens 21, the position of the optical pickup 20, and consumed power. In FIG. 9, (a) shows a transition in the position of the object lens 21 in the optical pickup 20. In FIG. 9, (b) shows a transition in the position of the optical pickup 20 in the optical disk device 100. In FIG. 9, (c) shows a transition in consumed power.

When mounting is started at a time t0 in FIG. 9, the drive control unit 63 starts focus adjustment and tracking control for the object lens 21 and a movement of the optical pickup 20 (hereinafter referred to as “Sled driving” as necessary) (S101 in FIG. 2). As in Embodiment 1, the drive control unit 63 performs the focus adjustment and tracking control for the object lens 21, according to a current temperature and the thickness of a disc.

At this time, as shown in (a) of FIG. 9, the drive control unit 63 causes the object lens 21 to move toward the trace side (the outer periphery side of the optical disc D), tracking the position of a track of the optical disc D. The power consumption of the optical disk device 100 at this time is calculated according to the power consumption Ws required to move the optical pickup 20+the other power consumption Wa.

At a time t1 in FIG. 9, the drive control unit 63 moves the object lens 21 to the center side position r4 (S201 in FIG. 2). Here, the position r4 is set further closer to the center side than a center position r0. The position r4 may be a physically limited position at the center side of the object lens 21.

By moving the object lens 21 in this way, the distance between the center position r0 and a trace position r1<the distance between the position r4 and the trace position r1 is satisfied. Thus, it is possible to lengthen the movement distance of the object lens 21. In other words, it is possible to lengthen a period that lasts until the optical pickup 20 is driven next.

The power consumption of the optical disk device 100 at this time is calculated according to the power consumption Ws required to move the optical pickup 20+the other power consumption Wa.

After the drive control unit 63 moves the object lens 21 to the position r4 (the time t1 in FIG. 9), it controls the movement mechanism driver unit 41 so as to stop the driving of the optical pickup movement mechanism 40 (S103 in FIG. 8, a time t2 in FIG. 9) and drives the collimator 22 (S104 in FIG. 8, times t2 to t3 in FIG. 9). Since the object lens 21 is moved to the position r4 in Step S201 so as to lengthen the period that lasts until the optical pickup 20 is driven next as described above, it is possible to complete adjustment for the collimator 22 by the time the optical pickup 20 is moved next. The position r4 is set to allow the object lens 21 to move to the trace side sequentially for a time duration longer than the time required to adjust the position of the collimator 22. In other words, the time is set to satisfy (r1−r4)/a movement speed of the object lens 21>a driving period of the collimator 22.

The power consumption of the optical disk device 100 at this time is calculated according to the power consumption Wc required to drive the collimator 22+the other power consumption Wa.

After the adjustment of the collimator 22 is finished (a time t3 in FIG. 9), the drive control unit 63 causes the optical pickup movement mechanism 40 to start driving, thereby causing the optical pickup 20 to start moving (S105 in FIG. 8) and adjusting the position of the object lens 21 (S202). Furthermore, the drive control unit 63 adjusts another mechanism (S107).

The power consumption of the optical disk device 100 at this time is calculated according to the power consumption Ws required to move the optical pickup 20+the other power consumption Wa.

As explained above, as shown in (c) of FIG. 9, a value indicating a peak in the power consumed by the optical disk device 100 in mounting is calculated according to the power consumption Wc required to move the collimator 22+the other power consumption Wa.

### [2-1-2. A Temperature Adjustment Process]

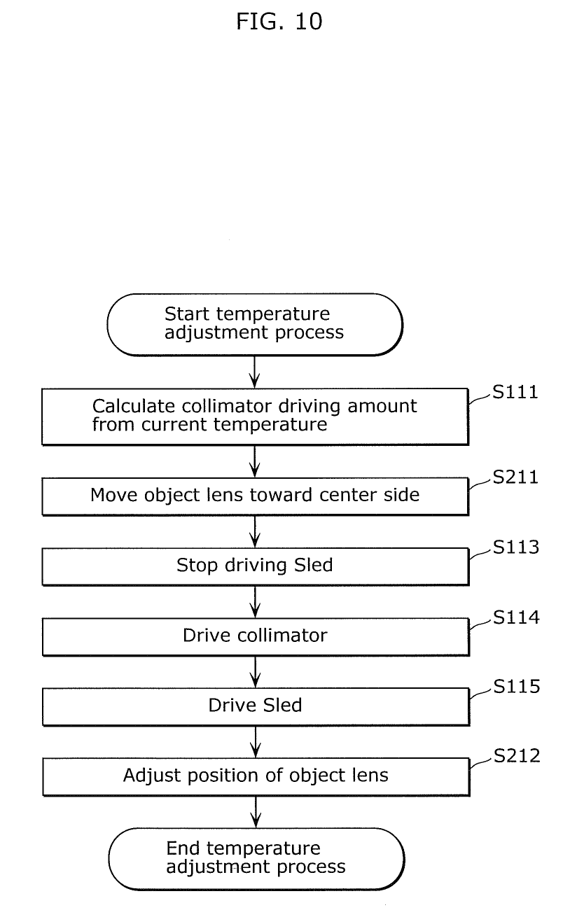

A temperature adjustment process performed by an optical disk device 100 is explained based on FIG. 10.

FIG. 10 is a flowchart of a procedure of the temperature adjustment process. Here, the same steps as in Embodiment 1 shown in FIG. 4 are assigned with the same reference numerals.

Here, as in Embodiment 1, the temperature adjustment process is performed each time a previously adjusted temperature of the optical pickup 20 changes by 10 degrees Celsius, based on temperature information from the temperature sensor 50. It is to be noted that the timing at which the temperature adjustment process is performed is not limited to the timing at which the temperature changes by 10 degrees Celsius. In the temperature adjustment process, a tilt amount of the object lens 21 is re-adjusted, and the position of the collimator 22 is re-adjusted.

When the temperature adjustment process is started, the drive control unit 63 of the control unit 60 calculates a driving amount (a movement amount) of the collimator 22, using the previously adjusted temperature and a current temperature of the optical pickup 20 (S111). Furthermore, the drive control unit 63 moves the object lens 21 to the center side position r4 (S211). The drive control unit 63 moves the object lens 21 to the position r4, and then causes the optical pickup 20 (Sled) to stop driving (S113).

The power consumption of the optical disk device 100 at this time is calculated according to the power consumption Ws required to move the optical pickup 20+the other power consumption Wa.

After stopping the movement of the optical pickup 20, the drive control unit 63 drives the collimator 22 (S114).

The power consumption of the optical disk device 100 at this time is calculated according to the power consumption Wc required to move the collimator 22+the other power consumption Wa.

The drive control unit 63 causes the optical pickup movement mechanism 40 to re-start a movement of the optical pickup 20 (S115), and adjusts the position of the object lens 21 (S212).

The power consumption of the optical disk device 100 at this time is calculated according to the power consumption Ws required to move the optical pickup 20+the other power consumption Wa.

Here, the collimator 22 and the Sled are not driven at the same time also in the temperature adjustment process in this embodiment, and thus a peak value in power consumed by the optical disk device 100 is calculated according to the power consumption Wc required to move the collimator 22+the other power consumption Wa, as shown in (c) in FIG. 9.

### [2-2. A Conclusion Etc.]

The optical disk device 100 in this embodiment moves the object lens 21 to the position r4 which is further closer to the center side than the center position r0, and then moves the collimator 22 which consumes a large amount of power. In this way, it is possible to eliminate the necessity of driving the optical pickup 20 during the driving period of the collimator 22, and to stop the driving of the optical pickup movement mechanism 40.

Accordingly, as shown in (c) of FIG. 9, the peak value in the power consumed by the optical disk device 100 in this embodiment is calculated according to the power consumption Wc required to move the collimator 22+the other power consumption Wa.

As described above with reference to (c) of FIG. 5, the peak value in the power consumed by the conventional optical disk device is calculated according to a power consumption Ws required to drive the Sled+a power consumption Wc required to move the collimator 22+the other power consumption Wa.

In other words, the optical disk device 100 in this embodiment is capable of reducing the power peak value by the power consumption Ws required to drive the Sled as in the case of the optical disk device 100 in Embodiment 1.

### Embodiment 3

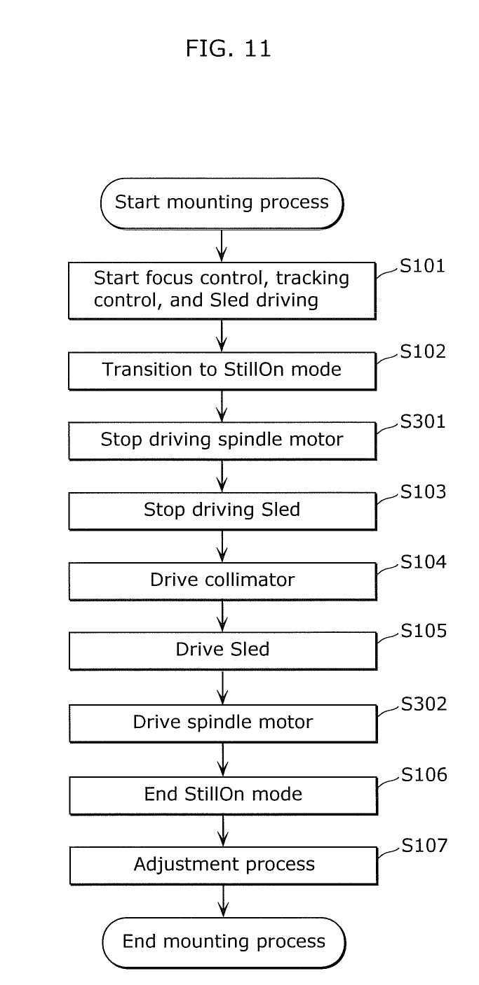

An optical disk device according to Embodiment 3 is explained based on FIGS. 11 to 13.

In this embodiment, a description is given of a case of controlling driving of a spindle motor 10, in addition to driving of an object lens 21 and an optical pickup movement mechanism 40 (an optical pickup 20) by the drive control unit 63 in Embodiment 1.

It is to be noted that the optical disk device in this embodiment is the same as the optical disk device 100 shown in FIG. 1 except for the method of driving the spindle motor 10 by the drive control unit 63.

### [3-1. Operations Performed by an Optical Disk Device]

Operations by the optical disk device 100 are explained based on FIGS. 11 to 13.

In this embodiment as in Embodiment 1, a mounting process and a temperature adjustment process are described as adjustment processes performed by the optical disk device 100.

### [3-1-1. Mounting]

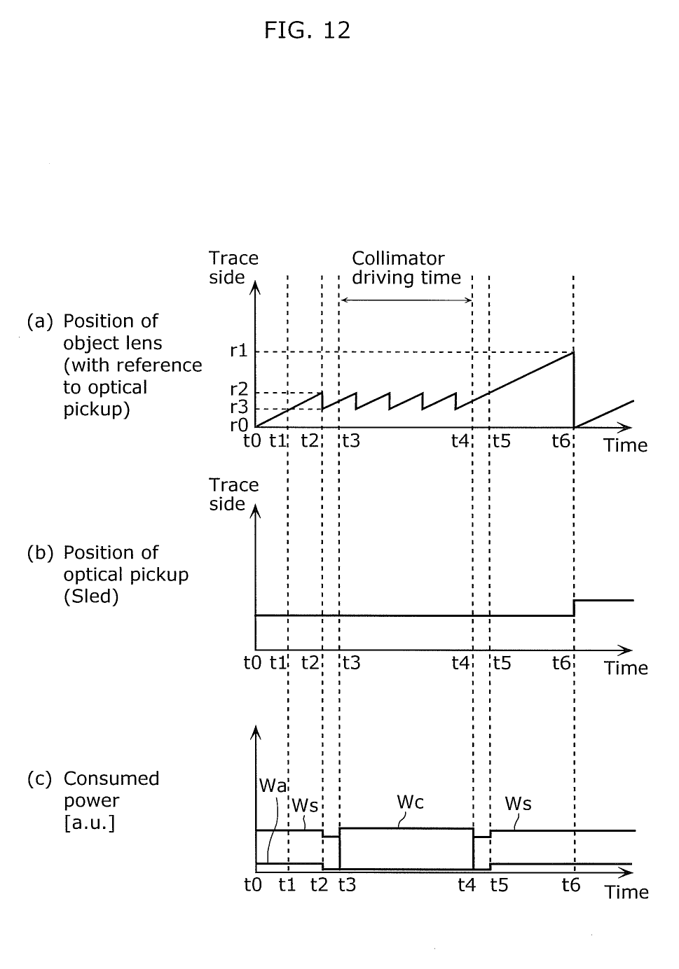

Mounting by the optical disk device 100 in this embodiment is explained based on FIGS. 11 and 12.

FIG. 11 is a flowchart of a mounting procedure. Here, the same steps as in Embodiment 1 shown in FIG. 2 are assigned with the same reference numerals.

FIG. 12 is a graph showing transitional relationships between the position of the object lens 21, the position of the optical pickup 20, and consumed power. In FIG. 12, (a) shows transition in the position of the object lens 21 in the optical pickup 20. In FIG. 12, (b) shows transition in the position of the optical pickup 20 in the optical disk device 100. In FIG. 12, (c) shows transition in consumed power.

When mounting is started at a time t0 in FIG. 12, the drive control unit 63 starts focus adjustment and tracking control for the object lens 21 and a movement of the optical pickup 20 (S101 in FIG. 11). As in Embodiment 1, the drive control unit 63 performs the focus adjustment and tracking control for the object lens 21, according to a current temperature and the thickness of a disc.

When a time t1 in FIG. 12 is reached, the drive control unit 63 transitions to a StillOn mode (still mode) in which light from the LD 24 is focused on the optical disc D without causing a reproducing unit 61 to read (decode) an RF signal (S102 in FIG. 11).

In the StillOn mode, the drive control unit 63 controls a spindle motor driver unit 11 so as to cause the spindle motor 10 to stop driving (S301 in FIG. 11, a time t2 in FIG. 12, a step of stopping the optical disc rotation unit). Here, to stop driving here means to stop supply of a drive current to the spindle motor 10, and does not mean to stop rotating the spindle motor 10 and the optical disc D. In other words, even if supply of the drive current to the spindle motor 10 is stopped, the rotation speed of the optical disc D does not stop immediately and gradually reduces. This point is focused on in this embodiment. At the time when the collimator 22 is driven, adjustment for the collimator 22 is made while driving of the spindle motor 10 is stopped and a rotation speed of the optical disc D is ensured to allow the adjustment for the collimator 22.

When the power consumed to drive the spindle motor 10 is Wp, the power consumption of the optical disk device 100 at this time is calculated according to Ws+Wa−Wp.

Furthermore, the drive control unit 63 controls a movement mechanism driver unit 41 to cause the optical pickup movement mechanism 40 to stop driving (S103 in FIG. 11), so as to adjust the position of the collimator 22 (S104, a time t3 in FIG. 12, a step of causing the collimator driver unit to operate).

The power consumption of the optical disk device 100 at this time is calculated according to Wc+Wa−Wp.

When the adjustment for the collimator 22 is finished, and the driving of the collimator 122 is stopped, the drive control unit 63 re-starts driving of the optical pickup movement mechanism 40, thereby causing the optical pickup 20 to re-start moving (S105 in FIG. 11, a time t4 in FIG. 12).

The power consumption of the optical disk device 100 at this time is calculated according to Ws+Wa−Wp.

Furthermore, the drive control unit 63 causes the spindle motor driver unit 11 to re-start driving (S302 in FIG. 11, a time t5 in FIG. 12, a step of causing the optical disc rotation unit to re-start operating, and terminates the StillOn mode (S106 in FIG. 11).

After the StillOn mode is terminated at the time t5, the drive control unit 63 performs an adjustment for another mechanism (S107). At this time, the drive control unit 63 causes the object lens 21 to repeat a movement to the trace position r1 and a movement to the center position r0. Furthermore, when the object lens 21 moves to the trace position as shown at a time t6 for example, the drive control unit 63 causes the optical pickup 20 to move in the trace direction.

The power consumption of the optical disk device 100 at this time is calculated according to Ws+Wa.

As explained above, as shown in (c) of FIG. 12, a value indicating a peak in the power consumed by the optical disk device 100 in mounting is calculated according to the power consumption Wc required to move the collimator 22+the other power consumption Wa−the power consumption Wp of the spindle motor driver unit 11.

### [3-1-2. A Temperature Adjustment Process]

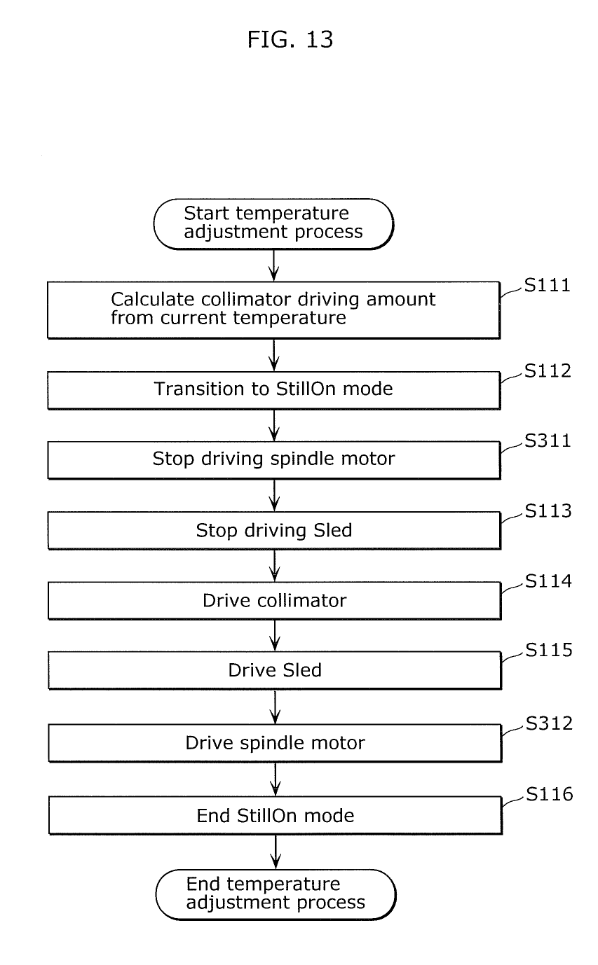

A temperature adjustment process performed by the optical disk device 100 in this embodiment is explained based on FIG. 13.

FIG. 13 is a flowchart of a procedure of the temperature adjustment process. Here, the same steps as in Embodiment 1 shown in FIG. 4 are assigned with the same reference numerals.

Here, in Embodiment 1, the temperature adjustment process is performed each time a previously adjusted temperature of the optical pickup 20 changes by 10 degrees Celsius, based on temperature information from the temperature sensor 50. It is to be noted that the timing at which the temperature adjustment process is performed is not limited to the timing at which the temperature changes by 10 degrees Celsius. In the temperature adjustment process, a tilt amount of the object lens 21 is re-adjusted, and the position of the collimator 22 is re-adjusted.

When the temperature adjustment process is started, the drive control unit 63 of the control 60 calculates a driving amount (a movement amount) of the collimator 22, using the previously adjusted temperature and a current temperature of the optical pickup 20 (S111).

The drive control unit 63 causes the reproducing unit 61 to stop reading (decoding) an RF signal, and makes a transition to a StillOn mode (S112).

The drive control unit 63 causes the spindle motor driver unit 11 to stop driving of the spindle motor 10 (S311, a step of stopping the optical disc rotation unit).

The drive control unit 63 causes the optical pickup movement mechanism 40 to stop a movement of the optical pickup 20 (S113).

The power consumed by the optical disk device 100 in S111 to S113 is calculated according to the power consumption Ws required to move the optical pickup 20+the other power consumption Wa−the power consumption Wp required to drive the spindle motor 10.

After stopping the movement of the optical pickup 20, the drive control unit 63 drives the collimator 22 (S114, a step of causing the collimator driver unit to operate).

The power consumption of the optical disk device 100 at this time is calculated according to the power consumption Wc required to move the collimator+the other power consumption Wa.

The drive control unit 63 causes the optical pickup movement mechanism 40 to re-start moving the optical pickup 20 (S115), re-starts supply of a drive current to the spindle motor 10 (S312, a step of causing the optical disc rotation unit to re-start operating), and terminates the StillOn mode (S116).

Here, the collimator 22, the optical pickup movement mechanism 40 (Sled) and the spindle motor are not driven at the same time also in the temperature adjustment process, and thus a peak value in power consumed by the optical disk device 100 is calculated according to the power consumption Wc required to drive the collimator 22+the other power consumption Wa, as shown in (c) in FIG. 3.

### [3-2. A Conclusion Etc.]

The optical disk device 100 in this embodiment causes the spindle motor 10 and the optical pickup movement mechanism 40 to operate during a period other than an operation period of the collimator driver unit 32 which consumes a large amount of power. Thereby, the optical disk device 100 can reduce the peak in the consumed power. It is to be noted that the peak value in the power consumed by the optical disk device 100 in this embodiment is calculated according to the power consumption Wc required to drive the collimator 22+the other power consumption Wa−the power consumption Wp required to drive the spindle motor 10.

It is to be noted that, in this embodiment, both of the spindle motor 10 and the Sled (the optical pickup movement mechanism 40) are caused to stop driving, only the spindle motor 10 may be caused to stop driving.

The optical disk device method in this embodiment is combined with the Sled driving method in Embodiment 1. However, the method of stopping the spindle motor 10 in this embodiment may be combined with the method of driving the object lens 21 and the Sled in Embodiment 2.

In this embodiment, the Sled is stopped after driving of the spindle motor 10 is stopped. However, the spindle motor 10 is stopped after driving of the Sled is stopped.

### Another Embodiment

The optical disk devices according to the embodiments of the present invention have been described above, but the present invention is not limited to these embodiments.

(1) The optical disk device in this embodiment may include an optical pickup having a plurality of optical members, to handle a plurality of media. In this case, a plurality of collimators in the optical disk device may be configured to drive in shifted driving periods so as not to drive at the same time, and the optical members other than the collimators are driven in periods in which the collimators is not driven, which makes it possible to suppress a peak in power to be consumed.

(2) In addition, the control unit 60 in the optical disk device is configured to include a CPU and a storage unit, but this is a non-limiting example. For example, the control unit 60 may be configured as a computer system including a microprocessor, a ROM, a RAM, a hard disk drive, a display unit, a keyboard, a mouse, etc. The RAM or the hard disk drive stores a computer program. The microprocessor operates according to the computer program, causing the respective devices exert their functions. Here, the computer program is designed to include a plurality of combinations of instruction codes showing commands to the computer.

Furthermore, a part or all of the structural elements of the respective apparatuses may be configured with a single system LSI (Large-Scale Integration). The system LSI is a super-multi-function LSI manufactured by integrating structural units on a single chip, and is specifically a computer system configured to include a microprocessor, a ROM, a RAM, and so on. A computer program is stored in the RAM. The system LSI achieves its function through the microprocessor's operations according to the computer program.

A part or all of the constituent elements constituting the respective apparatuses may be configured as an IC card which can be attached to and detached from the respective apparatuses or as a stand-alone module. The IC card or the module is a computer system configured from a microprocessor, a ROM, a RAM, and so on. The IC card or the module may also be included in the aforementioned super-multi-function LSI. The system LSI achieves its function through the microprocessor's operations according to the computer program. The IC card or the module may also be implemented to be tamper-resistant.

Furthermore, the present invention may be the method indicated above. In addition, the present invention may be implemented as computer programs for executing the above-described method, using a computer, and may also be implemented as digital signals including the computer programs.

Furthermore, the present invention may also be implemented as computer programs or digital signals recorded on computer-readable recording media such as a flexible disc, a hard disc, a CD-ROM, an MO, a DVD, a DVD-ROM, a DVD-RAM, a Blu-ray Disc (BD), and a semiconductor memory. Furthermore, the present invention may also be implemented as the digital signals recorded on these recording media.

Furthermore, the present invention may also be implemented as the aforementioned computer programs or digital signals transmitted via a telecommunication line, a wireless or wired communication line, a network represented by the Internet, a data broadcast, and so on.

The present invention may also be implemented as a computer system including a microprocessor and a memory, in which the memory stores the aforementioned computer program and the microprocessor operates according to the computer program.

Furthermore, it is also possible to execute another independent computer system by transmitting the programs or the digital signals recorded on the above-described non-transitory recording media, or by transmitting the programs or digital signals via the aforementioned network and the like.

Furthermore, the embodiments and variations may be arbitrarily combined.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present invention is useful for optical disk devices for DVDs, BD, etc.

1. An optical disk device comprising:
an optical pickup which (i) includes a collimator for collimating light from a predetermined light source to parallel light beams, and an object lens for focusing the parallel light beams from the collimator at a position on an optical disc, and (ii) reads data recorded on the optical disc;
a collimator driver unit configured to move the collimator in an optical axis direction;
an optical pickup movement unit configured to move the optical pickup in a radial direction of the optical disc; and
a drive control unit configured to perform an adjustment process for adjusting positions of the object lens and the collimator,
wherein, in the adjustment process, the drive control unit is configured to cause the collimator driver unit to operate after stopping the optical pickup movement unit, and cause the optical pickup movement unit to re-start operating after the collimator driver unit finishes moving the collimator.

2. An optical disk device comprising:
an optical pickup which (i) includes a collimator for collimating light from a predetermined light source to parallel light beams, and an object lens for focusing the parallel light beams from the collimator at a position on an optical disc, and (ii) reads data recorded on the optical disc;
a collimator driver unit configured to move the collimator in an optical axis direction;
an optical disc rotation unit configured to rotate the optical disc; and
a drive control unit configured to perform an adjustment process for adjusting positions of the object lens and the collimator,
wherein, in the adjustment process, the drive control unit is configured to cause the collimator driver unit to operate after stopping the optical disc rotation unit, and cause the optical disc rotation unit to re-start operating after the collimator driver unit finishes moving the collimator.

3. The optical disk device according to claim 2, further comprising
an optical pickup movement unit configured to move the optical pickup in the radial direction of the optical disc,
wherein, in the adjustment process, the drive control unit is configured to stop the optical pickup movement unit before causing the collimator driver unit to operate, and cause the optical pickup movement unit to re-start operating after the collimator driver unit finishes moving the collimator.

4. The optical disk device according to claim 1,
wherein, in the adjustment process, the drive control unit is configured to cause the collimator driver unit to operate after a transition to a still mode in which (i) the parallel light beams are focused on the optical disc and (ii) a signal read from the optical pickup is not decoded, and terminate the still mode after the collimator driver unit finishes moving the collimator.

5. The optical disk device according to claim 1,
wherein, in the adjustment process, the drive control unit is configured to focus the parallel light beams on one or more tracks on the optical disc.

6. The optical disk device according to claim 1,
wherein, in the adjustment process, the drive control unit is configured to move the object lens in a center direction of the optical disc before causing the collimator driver unit to operate, so as to move the object lens sequentially in a peripheral direction of the optical disc for a time duration longer than time required for the collimator driver unit to move the collimator.

7. The optical disk device according to claim 1,
wherein the control unit is configured to perform the adjustment process when the optical disk device is turned on, or the optical disc is mounted.

8. The optical disk device according to claim 1, comprising
a temperature sensor which detects a temperature, and outputs temperature information indicating the temperature,
wherein the drive control unit is configured to perform the adjustment process when a difference between the temperature indicated by the temperature information and a temperature at a time of a previous driving process is larger than or equal to a predetermined threshold value.

9. A driving method of driving an optical disk device,
wherein the optical disk device includes:
an optical pickup which (i) includes a collimator for collimating light from a predetermined light source to parallel light beams, and an object lens for focusing the parallel light beams from the collimator at a position on an optical disc, and (ii) reads data recorded on the optical disc;
a collimator driver unit which moves the collimator in an optical axis direction;
an optical pickup movement unit which moves the optical pickup in a radial direction of the optical disc; and
an optical disc rotation unit which rotates the optical disc,
the driving method comprising
stopping at least one of the optical pickup movement unit and the optical disc rotation unit while the collimator driver unit is operating.

10. The driving method according to claim 9, comprising:
stopping the optical pickup movement unit;
causing the collimator driver unit to operate after stopping the optical pickup movement unit; and
causing the optical pickup movement unit to re-start operating after finishing moving the collimator by the collimator driver unit.

11. The driving method according to claim 9, comprising:
stopping the optical disc rotation unit;
causing the collimator driver unit to operate after stopping the optical disc rotation unit; and
causing the optical disc rotation unit to re-start operating after finishing moving the collimator by the collimator driver unit.
